(19) United States
(12) Patent Application Publication
(10) Pub. No.: US 2004/0085120 A1
(43) Pub. Date: May 6, 2004

(54) Eliminating defective decoupling capacitors

(76) Inventor: Robert L. Pitts, Dallas, TX (US)

Correspondence Address: TEXAS INSTRUMENTS INCORPORATED, P O BOX 655474, M/S 3999, DALLAS, TX, 75265

(21) Appl. No.: 10/287,403

(22) Filed: Nov. 4, 2002

(51) Int. Cl. H01H 37/76

(52) U.S. Cl. 327/525

(57) ABSTRACT

An embodiment of the invention is circuitry that contains a fuse 9 connected between a decoupling capacitor 4 and a power rail 11. Another embodiment of the invention is a method of eliminating defective decoupling capacitors 4 by applying power to a power rail 10 to blow a fuse 9 that is connected to a defective decoupling capacitor 4.

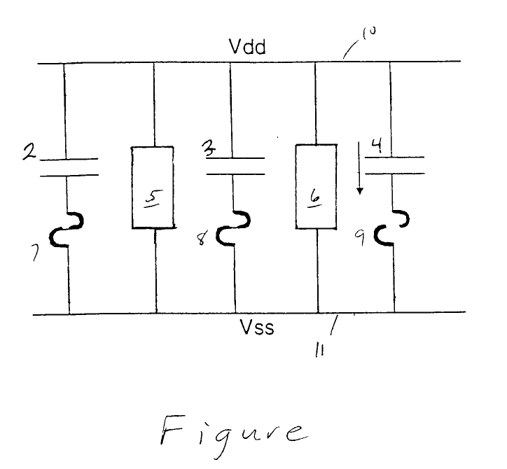

### BACKGROUND OF THE INVENTION

This invention relates to the elimination of shorted decoupling capacitors.

### BRIEF DESCRIPTION OF THE DRAWINGS

The DRAWING shows a circuit for eliminating defective decoupling capacitors in accordance with the invention.

### DETAILED DESCRIPTION OF THE INVENTION

A defective decoupling capacitor may cause a circuit's power supply to short to ground. This invention is a circuit and method for eliminating defective decoupling capacitors. Several aspects of the invention are described below with reference to example applications for illustration. It should be understood that numerous specific details, relationships, and methods are set forth to provide a full understanding of the invention. One skilled in the relevant art, however, will readily recognize that the invention can be practiced without one or more of the specific details or with other methods. In other instances, well-known structures or operations are not shown in detail to avoid obscuring the invention.

Referring to the drawing, decoupling capacitors 2, 3, 4 are coupled between two power rails 10, 11. These decoupling capacitors 2, 3, 4 protect the logic circuitry 5, 6 from transient voltage spikes and stabilize the supply voltage that is seen by the logic circuitry 5, 6. In the best mode application, power rail 10 is V_{dd} or V_{cc}. Also in the best mode application, power rail 11 is Vₛₛ or ground.

Decoupling capacitors 2, 3, 4 may be a single capacitor; however, in the best mode application they are an array of decoupling capacitors connected in parallel. Also in the best mode application, the decoupling capacitors are made from a highs dielectric film such as Ta₂O,; however, capacitors made from other materials such as gate oxide, metal plate capacitors, or metal flux capacitors are also within the scope of this invention.

Referring again to the drawing, there are fuses 7, 8, 9 that are coupled between power rail 11 and decoupling capacitors 2, 3, and 4 respectively. In the best mode application, fuses 7, 8, 9 are poly electrical fuses having a resistance of approximately 100 Ω. However, it is within the scope of this invention to use alternative fuses such as contact, via, or metal fuses. Moreover, it is within the scope of this invention to use fuses having a different resistance, for example a fuse having a nominal resistance anywhere from 10 Ω to 300 Ω. In the best mode application the resistance of the fuses 7, 8, 9 is kept to a minimal level in order to allow the non-defective decoupling capacitors to efficiently mitigate the effects of high frequency current glitches on the power rail 10.

When power is applied to the circuit on power rail 10 the nondefective decoupling capacitors will function in a manner that will support the logic circuitry 5, 6. However, if any decoupling capacitor has a shorting defect, for example in one or more of the capacitors in the capacitor array 4, then the defective decoupling capacitor may be very low resistance and act as a short that allows excessive current (i.e. up to tens of milliamps, depending on the supply voltage) to flow into the electrical fuse 9 connected to the capacitor array 4. This excessive current will overwhelm the fuse 9 and cause the fuse 9 to blow (i.e. become high resistance); thereby creating an open circuit and removing the defective decoupling capacitor array 4 from further operation.

Alternatively, the fuse 9 connected to the shorted decoupling capacitor 4 can be blown by raising the voltage level on power rail 10 to a level that opens the circuit (i.e. 1.5 to 2 times the normal operating voltage). The increased voltage only has to be present on power rail 10 for a short time (i.e. 2-3 ρs); therefore the voltage on rail 10 can be raised safely to any level below the reliability imposed voltage limit in order to open a circuit containing a defective decoupling capacitor.

Various modifications to the invention as described above are within the scope of the claimed invention. As an example, instead of the thin film decoupling capacitor described above, a transistor or other gate structure acting as a decoupling capacitor is within the scope of this invention. In addition, the functions comprehended by the invention could be accomplished in various technologies such as CMOS or TTL.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A circuit comprising:
at least one decoupling capacitor coupled between a first power rail and a second power rail; and
at least one fuse coupled between said at least one decoupling capacitor and at least one said power rail.

2. The circuit of claim 1 wherein said decoupling capacitor is comprised of gate oxide.

3. The circuit of claim 1 wherein one of said power rails is V_{dd} and the other one of said power rails is ground.

4. The circuit of claim 1 wherein said decoupling capacitor is comprised of high-k dielectric film.

5. The circuit of claim 1 wherein said fuse is a poly electrical fuse.

6. A circuit comprising:
two or more parallel decoupling capacitors coupled between a first power rail and a second power rail; and
one fuse connected between said decoupling capacitors and said first power rail.

7. The circuit of claim 6 wherein said fuse is a poly electrical fuse.

8. The circuit of claim 6 wherein said fuse has a nominal resistance below approximately 200 ohms.

9. The circuit of claim 6 wherein said decoupling capacitors are comprised of gate oxide.

10. The circuit of claim 6 wherein said decoupling capacitors are comprised of high-k dielectric film.

11. The circuit of claim 6 wherein said first power rail is ground.

12. The circuit of claim 6 wherein said second power rail is V_{dd}.

13. A method for eliminating defective capacitors comprising:
applying power to a circuit wherein a fuse connected to a shortened decoupling capacitor blows open.

14. The method of claim 13 wherein said fuse is blown by current flowing from a power rail, through said shortened decoupling capacitor, and then into said fuse.

15. The method of claim 13 wherein the level of said power is approximately V_{dd}.

16. The method of claim 13 wherein the level is said power is between V_{dd} and the maximum reliability imposed voltage limits of said circuit.
